(19) United States
(12) Patent Application Publication
(10) Pub. No.: US 2008/0189733 A1
(43) Pub. Date: Aug. 7, 2008

(54) Content rating systems and methods

(76) Inventor: John G. Apostolopoulos, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/591,317

(22) Filed: Oct. 31, 2006

(51) Int. Cl. H04N 7/16

(52) U.S. Cl. 725/28

(57) ABSTRACT

Content can be sent to a device that can render the content. The rendered content changes as a function of time. Rating values associated with the content can be sent to the device. The rating values represent at least one person's opinion of the content. The rating values are displayed and correspond to different moments in the content.

### TECHNICAL FIELD

Embodiments in accordance with the present invention relate to content distribution.

### BACKGROUND ART

Content distribution over the Internet is quite popular. Users are provided with a myriad of opportunities to listen to and/or view content such as music, podcasts, newscasts, and videos for purposes that include entertainment, social interaction, education and work. In many instances, users are presented with an opportunity to rate the content. For example, a user can rate an item of content on a scale of one to five. The users' ratings are compiled and continuously updated. When users wish to access an item of content, they are typically able to view its composite rating before doing so. Thus, before taking the time to listen to or view an item of content, users know what others think about it and can avoid content that is not rated highly. Alternatively, a higher rating may reflect content that is more interesting.

While conventional rating systems are helpful to a certain extent, a method and/or system that improves on such systems would be more valuable. Embodiments in accordance with the present invention provide this and other advantages.

### SUMMARY

In one embodiment, content is sent to a device that can render the content. The rendered content changes as a function of time. Rating values associated with the content can be sent to the device. The rating values represent at least one person's opinion of the content. The rating values are displayed and correspond to different moments in the content.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram showing an example of a system upon which embodiments of the present invention can be implemented.

FIG. 2 is a flowchart of a method for rating content and distributing rated content according to embodiments of the present invention.

FIG. 3 illustrates a format for displaying rating values according to an embodiment of the present invention.

FIG. 4 illustrates examples of other formats for displaying rating values according to embodiments of the present invention.

The drawings referred to in this description should not be understood as being drawn to scale except if specifically noted.

### DETAILED DESCRIPTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

The descriptions and examples provided herein are generally applicable to different types of data. In one embodiment, the descriptions and examples provided herein are applicable to media data (also referred to herein as “multimedia data,” “media content” or simply “content”). One example of content is video data accompanied by audio data. However, content can be video only, audio only, or both video and audio. In general, the present invention, in its various embodiments, is well-suited for use with speech-based data, audio-based data, image-based data, Web page-based data, graphic data and the like, and combinations thereof.

The term “rendered” is used herein in a general sense. For example, if the content consists of audio-based data, then the content can be rendered audibly; if the content consists of image-based, then the content can be rendered visibly (e.g., displayed); and if the content consists of both audio-based and image-based, then the content can be rendered both audibly and visibly. The term “play” or “playback” may also be used herein as an alternative to “render.”

An item of content may include a movie or a live event that has been captured and recorded, or a live event that is to be distributed in real time. One item of content may be differentiated from another. For example, a first item of content may have one title and a second item of content may have a different title. There are other ways to differentiate between items of content. An item of content may be identified as such using the packet identifier code (PID) assigned when the content is encoded—the output of the encoder may be referred to as an elementary stream, and packets in the same elementary stream have the same packet identifier code PID. An item of content may be identified as such using an object descriptor (OD)—an item of content has its own OD identifier. The OD may point to a list of elementary stream descriptors that point to one or more streams with data or side information for the item of content. An item of content may be identified as such using an intellectual property identification (IPI) descriptor—an item of content has its own IPI descriptor. If multiple items of content are identified by the same IPI information, the IPI descriptor may consist of a pointer to another elementary stream or PID. An item of content may be identified by its own Uniform Resource Locator (URL). There may be other ways to distinguish one item of content from another.

Embodiments in accordance with the present invention pertain to items of content that have a time dimension. That is, some aspect or characteristic of the content changes as the content is rendered. For example, as a video is displayed on a display screen, the information (e.g., images) presented to a viewer changes over time—what the user sees is time-dependent.

In overview, embodiments in accordance with the present invention allow users to rate the content as a function of time. For example, while viewing a video, a user can assign a first rating value to one part of the content, a second rating value at another part, and so on. Each rating value represents the user's opinion of a corresponding part of the content.

A rating value can be associated with a particular point in the content or it can be associated with a segment of the content (e.g., a segment that includes that point). For example, a rating value entered while a frame of video is being displayed may be associated with that frame or with a window of frames that includes that frame. In the latter case, the window may begin with that frame or it may be extended to include frames on either side of that frame. The length of such a window may be a prescribed length, or it may extend until another rating value is entered. The window may be automatically detected by a variety of techniques which process the content to identify appropriate windows for assigning ratings. For example, a video may be processed by scene detection or video summarization techniques that attempt to identify segments of video that are coherent, for instance a scene in a movie or a football play or a news program segment. As another example, video event detection can be used to detect important events such as a goal in a soccer game and a ranking can be associated with this event. Alternatively, the content itself may contain metadata information that describes the appropriate segments of the content. Also, a user can be prompted to enter a rating value at prescribed time intervals as the content is rendered or at prescribed points of the content (e.g., at a scene change in a video). However, a user can also enter rating values even when the content is not being played. That is, for example, a user can enter rating values after viewing or listening to the content, perhaps in response to prompts that identify various parts of the content.

A rating value can also be associated with content by beginning playback of the content and then keeping track of elapsed time from the beginning of playback until playback is ended. As rating values are entered, they can be associated with an amount of elapsed time, and thus in turn can be correlated to different points in the content.

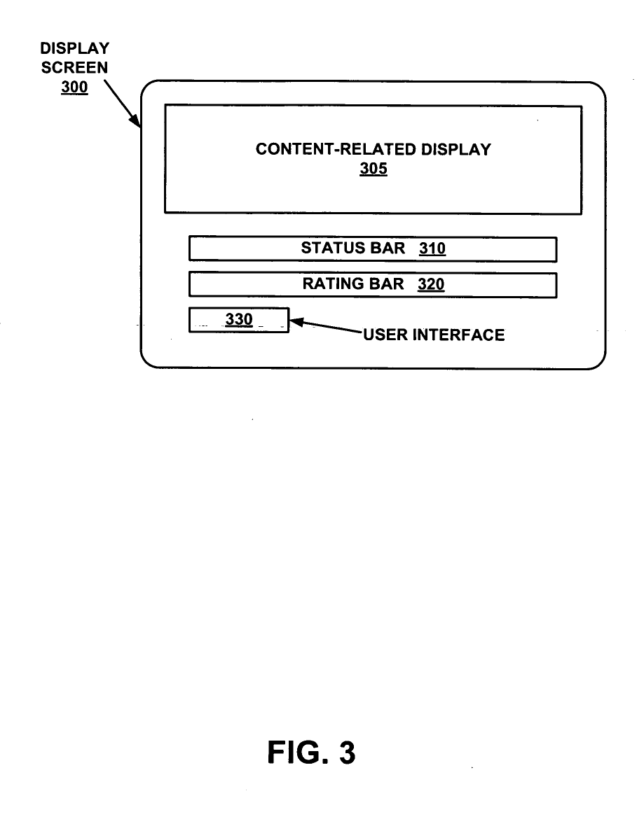

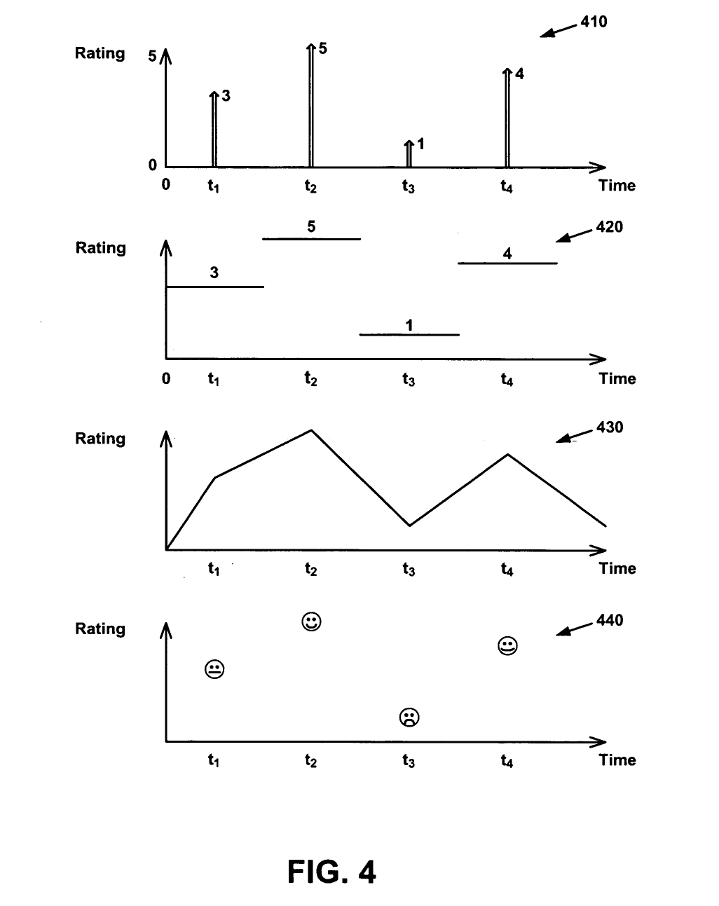

The time-dependent rating values contributed by different users can be compiled into composite but still time-dependent rating values. When a user subsequently accesses the content, the composite rating values can be provided and displayed in advance of or along with the content. The composite rating values can be displayed in different ways, some of which are described below in conjunction with FIGS. 3 and 4.

There are many ways to gather rating values as a function of time. For instance, a user may enter any value within a given range of values and then can vary that value at any time. In this case, the rating may have the appearance of a stepwise function (like a staircase) that goes up or down at the points where the rating is changed by the user. In other words, in this example, the rating value is assumed to stay constant at the points between the points where the rating value is changed.

Alternatively, the rating values may be interpolated. For example, a subset (e.g., a moving average filter) may be applied to the discrete rating values to make the rating appear more continuous over time. Accordingly, the rise and fall of the rating as the content is rendered would be apparent.

Also, a user can enter a rating value a little late (e.g., after the portion of content to be rated has already passed), because the interpolation helps ensure that the rating's effect is applied over a window that extends both before and after the instant when the rating value was entered. The issue of late inputs can instead be addressed by automatically applying the rating value to a window of prescribed length (in a manner similar to that described above) or by automatically applying the rating value to a point in time that precedes the instant when the rating value was entered (e.g., an amount of delay can be assumed, and the delay is accounted for by subtracting that amount from the timestamp associated with each rating value).

As another alternative, the rating value may remain unspecified at the points between the points where the rating value is changed or a new rating value is entered. This approach has the benefit of clearly identifying when a rating value is entered.

In one embodiment, information associated with the user (e.g., the user's name, a pseudonym such as a screen name, or some type of anonymous identifier) is also associated with the rating values entered by the user for an item of content. Accordingly, when the rating values are subsequently displayed, the user uniquely associated with those rating values can be identified. Similarly, when composite rating values (based on multiple users' inputs) are subsequently displayed, a particular user's rating can be separated from the composite values. In this manner, another user can perhaps learn which of the other users share similar tastes, and perhaps can seek out content rated highly by those users while avoiding content that have low ratings from those users.

Furthermore, by identifying a user with his or her ratings, an item of content preferred by the user can be more readily identified, facilitating subsequent access to that content by the user. Also, other content that may be similar to the rated content and that received similar ratings from other users can be identified as being of potential interest to a user. For example, if user A rates content X highly, and content Y is similar in genre to content X and is also rated highly, then content Y may be of interest to user A and can be identified as such to user A. As another example, if users A, B, and C have highly correlated ratings (e.g., they typically have the same preferences), then if users B and C rate a piece of content highly, then that content may be recommended to user A if user A has not already seen that content. These recommendations may be for the entire content or only for the portions at specific times that have been, for example, rated highly.

The content and its ratings can be associated. For example, links (e.g., similar to a hyperlink) may be provided that enable a user to directly go to the time(s) or place(s) in the content that are identified to be of greatest potential interest to the user. By “selecting” a particular rating value (e.g., by positioning a mouse-controlled cursor over a particular rating value and then “clicking” the mouse), a point in the content directly associated with that particular rating value is accessed and the content is rendered beginning at that point. This capability is very useful, as the ratings allow a user to identify what portion(s) of the content are, for example, potentially the most interesting (e.g., highly rated) and to go directly to those portions of the content.

Also, a user A can identify portions of the content that are most appropriate for viewing or listening by user B. Accordingly, it is much simpler for user A and user B to communicate about selected portions of the content (e.g., those portions that are considered to be the most important or the most interesting), and enables user B to directly focus attention on those portions of the content.

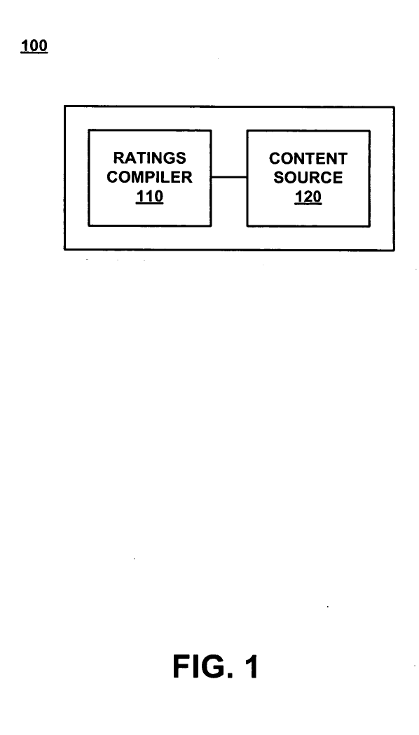

FIG. 1 is a block diagram showing an example of a system 100 upon which embodiments of the present invention can be implemented. In general, the elements of FIG. 1 are described according to the functions they perform. However, elements may perform functions in addition to those described herein. Also, functions described as being performed by multiple elements may instead be performed by a single element. Similarly, multiple functions described as being performed by a single (e.g., multifunctional) element may instead be divided in some way amongst a number of individual elements. Furthermore, the system of FIG. 1 and each of its elements may include elements other than those shown or described herein.

In the example of FIG. 1, the system 100 includes a ratings compiler 110 and a content source 120 (e.g., a memory). As mentioned above, the system 100 may include other elements such as a central processing unit, a transmitter and a receiver. System 100 can be communicatively coupled (e.g., wired or wirelessly) to a content delivery network. In one embodiment, system 100 is implemented as part of a Web server.

In one embodiment, ratings compiler 110 receives time-dependent rating values from one or more users, representing the user's or users' opinions of the content and corresponding to various points in the content. In one such embodiment, the ratings compiler 110 aggregates (e.g., averages, interpolates, etc.) the rating values from multiple users to produce time-dependent composite rating values that correspond to various points in the content.

In one embodiment, content source 120 sends the content and the time-dependent rating values, which may include time-dependent composite rating values, to another device (e.g., an end user's device, not shown).

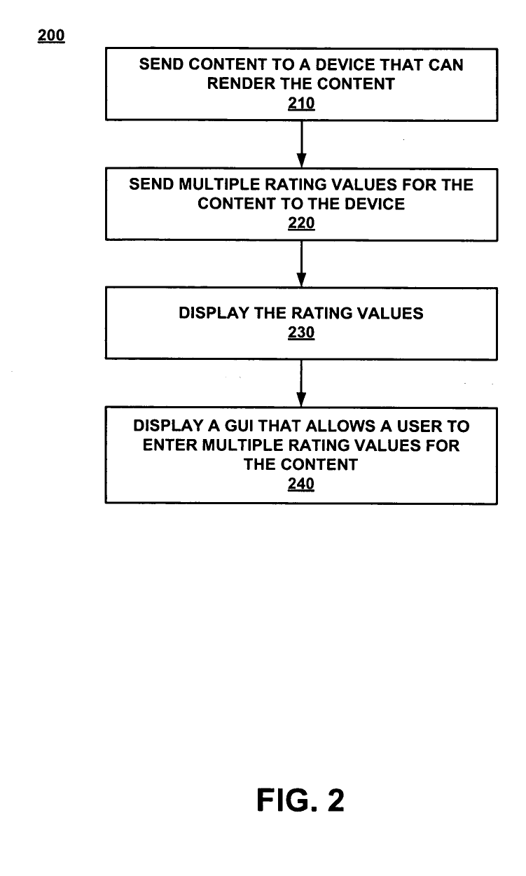

FIG. 2 is a flowchart 200 of a method for rating content and distributing rated content in accordance with various embodiments of the present invention. Although specific steps are disclosed in the flowchart, such steps are exemplary. That is, embodiments of the present invention are well-suited to performing various other steps or variations of the steps recited in the flowchart. The steps in the flowchart may be performed in an order different than presented, and not all of the steps in the flowchart may be performed. All of, or a portion of, the methods described by the flowchart may be implemented using computer-readable and computer-executable instructions which reside, for example, in computer-usable media of a computer system. In one embodiment, the methods described by flowchart 200 are implemented using system 100 of FIG. 1; however, as mentioned previously herein, embodiments in accordance with the present invention are not limited to the example system of FIG. 1.

In block 210 of FIG. 2, content that has a time dimension is sent to a device that can render (play) the content.

In block 220, rating values associated with the content are sent to the device. The rating values correspond to different moments in the content. The rating values may represent composite rating values contributed by multiple users or they may represent the ratings of a single user.

In block 230, the rating values are displayed. The rating values can be displayed in various formats, examples of which are provided in FIGS. 3 and 4, below.

In one embodiment, information identifying a person that contributed to the rating values is provided with the rating values.

In block 240 of FIG. 2, in one embodiment, a graphical user interface (GUI) that is useful for receiving time-dependent rating values is also displayed. As a user views and/or listens to the content, the GUI provides a ready means of entering rating values at different points in time. The rating values can be entered as the content is rendered or subsequent to the rendering.

In one embodiment, a user is prompted to enter a rating value at periodic intervals.

In one embodiment, the time that has elapsed since the start of the rendering is monitored. When a rating value is received, the amount of elapsed time is recorded and associated with the rating value. In such an embodiment, the elapsed time and the associated rating value are stored in a table in which the elapsed time serves as an index to the associated rating value. In one such embodiment, the elapsed time corresponds to the time at which a rating value is entered. In another such embodiment, the elapsed time is measured in fixed increments, and the rating value last entered by the user is stored automatically until a new rating value is entered. As an alternative, each rating value essentially expires as each time increment transpires; that is, if a new rating value has not been entered during a given time interval, then no rating value is specified for that time interval.

In general, when a rating value is entered as the content is rendered, the point in the content that was being rendered when the rating value was entered is identified in some manner, so that the rating value can be associated with that point or with a window (segment) of the content that includes that point.

FIG. 3 illustrates a format for displaying rating values according to one embodiment of the present invention. In the example of FIG. 3, display screen 300 includes a content-related display 305, a status bar 310, a rating bar 320, and a user interface 330. There may be graphical elements and displays in addition to those shown. For example, graphical elements representing buttons for controlling content rendering (e.g., a play button, a stop button, a “rewind” button, a fast forward button, etc.) may be displayed.

In the example of FIG. 3, content-related display 305 represents an area of display 300 that is associated with the content being rendered. For example, a video may be rendered in content-related display 305. If the content is audio in nature, then content-related display 305 may display related information such as a play list or the like.

In the example of FIG. 3, status bar 310 is used to indicate how much of the content has been played (or how much of the content remains to be played). In essence, status bar 310 is a graphical representation of the content being rendered; each point in status bar 310 corresponds to a point in the content being rendered.

In one embodiment, rating bar 320 represents the time-dependent rating values associated with the content being played. The rating values represented using rating bar 320 can represent the composite rating values compiled from the rating values contributed by multiple users. Alternatively, the rating bar 320 may represent the rating values from a single user. In one such embodiment, rating bar 320 is essentially the same length as status bar 310, and is situated in proximity to and parallel with status bar 310. Thus, each point on rating bar 320 may correspond to a point in status bar 310 and thus to a point in the content being rendered.

In one embodiment, rating bar 320 includes a plot showing rating values versus time, with rating values on the vertical (y) axis and elapsed time on the horizontal (x) axis. In such an embodiment, rating bar 320 thus shows the rating value at different points in the content.

In another embodiment, rating bar 320 may be color-coded. For example, rating bar 320 may incorporate different colors as a function of rating value. One part of rating bar 320 may be one color, another part a different color, and so on. For example, highest rated points in the content may be represented using red, lowest rated points may be represented using blue or black, with points rated in between represented using some combination of the two colors or using other colors. As an alternative, the rating may be indicated using a grayscale intensity, where white corresponds to a rating at one extreme and black to a rating at the other extreme, and the grayscale values in between are appropriately associated with the other ratings (e.g., the higher the rating, the brighter the grayscale value).

In addition, there may be multiple rating bars like rating bar 320 associated with a single piece of content. The ratings bars may describe the ratings from different individuals or different groups of people. For example, for a political debate in the United States, there may be a rating bar that represents the ratings of each political party (e.g., one rating bar associated with Republicans, one associated with Democrats, and so on).

Alternatively, there may be multiple rating bars associated with a single piece of content, which each rating bar associated with a different attribute of the content. For example, one rating bar may represent the amount or quality of the action in the content, and another rating bar may represent the amount or quality of humor in the content.

In one embodiment, a user interface 330 is also provided so that a user can enter rating values as the content is being rendered. Different types of user interfaces may be employed for this purpose. For example, the user interface 330 may be a graphical element such as box; a user may enter a rating value in the box at periodic intervals, perhaps in response to a prompt. A rating value entered into the box may remain there until a new rating value is entered, or it may disappear after a prescribed period of time, allowing a new rating value to be entered.

Alternatively, user interface 330 may include icons representing an up arrow and a down arrow, or a thumbs-up and a thumbs-down, allowing a user to increase or decrease a displayed rating value by “clicking” on the appropriate icon using a mouse-controlled cursor. As another alternative, user interface 330 may include a number of star icons (e.g., zero stars, 1 star, 2 stars, . . . , 5 stars), where the user clicks on the appropriate number of stars that corresponds to his/her rating. As yet another alternative, the user interface 330 may include a drop down menu where multiple ratings are provided in the menu (e.g., a 5-point scale, where 5 is highest and 1 is lowest rating). As another alternative, the buttons or scroll wheel on a mouse or keyboard coupled to the display screen 300 may be used to select and enter rating values.

FIG. 4 illustrates other examples of formats for displaying rating values according to embodiments of the present invention. The examples of FIG. 4 are intended to show some of the variety of formats that can be used; however, the present invention is not limited to these examples. In a manner similar to the example of FIG. 3, the rating bar examples described below can be located in proximity to and parallel with status bar 310, to indicate the relationship between each rating value and a corresponding point in the content being rendered.

Rating bar 410 shows rating values versus time; in particular, rating values at specific points in time are shown (in general, the time values represent elapsed time measured from the beginning of the rendered content). The lengths of the time intervals between the time values t1, t2, t3 and t4 can be the same or they can be different. In other words, the rating values that are displayed using rating bar 410 (as well as in the other examples described herein) are composites of the rating values contributed by one or more users, and the rating values displayed reflect the intervals at which the rating values are entered by those users.

Rating bar 420 is an example in which a rating value entered at a particular time (e.g., at time t1) is extended to encompass a window of time (and a corresponding portion of the content) before and after time t1.

Rating bar 430 is an example in which adjacent rating values are interpolated.

As previously discussed, the rating bar may also use different colors to express the different ratings (e.g., red for high, yellow for medium, and black for low), or different grayscale values (e.g., white to gray to black) to represent the different ratings.

Rating bar 440 is an example in which a particular icon is selected to represent a rating value, depending on the value of the rating value. For example, if the rating values have a possible range of values, one type of icon is selected to represent a rating value that lies in a first part of the range, another type of icon is selected to represent a value that lies in a second part of the range, and so on.

Furthermore, the ratings may correspond to different attributes of the content. For example, the ratings could identify what portions of the content contain “action” or “humor,” or what portions of the content contain “background information” or “critical information.”

Also, as mentioned previously herein, there may be multiple rating bars associated with the content being rated, with one rating bar used to indicate the amount or quality of the action and another the amount or quality of the humor, for example. Rather than simply indicating the different attributes associated with different parts of the content, or rather than simply indicating whether or not certain parts of the content may or may not be interesting, the different attributes associated with the content may themselves be quantified (rated).

In addition, multiple ratings bars can be used to describe the ratings from different individuals or different groups of people.

In another embodiment, users can be provided with options for representing the rating values they contribute, thus personalizing the ratings. Users can also be provided with options on how they want to view the ratings contributed by others.

In summary, embodiments in accordance with the present invention provide methods and systems that allow multiple rating values, rather than just a single rating value, to be associated with a single item of content. In particular, time-dependent rating values can be input, aggregated or compiled with the rating values input by others, and displayed. For items of content such as movies or videos of sporting events that are relatively long, it may not be possible or desirable for users to summarize their opinion of the content with a single value. According to embodiments of the present invention, users are provided with the opportunity to rate content with a degree of granularity not available with conventional approaches.

Furthermore, because different points in the content can be associated with different rating values, users can use the composite rating values to identify which points in the content may be of the most interest. For example, one part of a recorded sporting event may hold more interest than another part; by rating the former part higher than the latter, users can more readily locate the points in the content that are potentially the most interesting.

Furthermore, portions of content that are most appropriate for viewing or listening by another user can be identified. This enables the second user to directly focus attention on selected (e.g., recommended) portions of the content.

Furthermore, the improved granularity provided for rating content can be used to provide better recommendations of content that may be preferred by a user. The finer grain information available about what a user likes and dislikes, for example, can directly lead to improved recommendations for that user.

Embodiments of the present invention are thus described. While the present invention has been described in particular embodiments, it should be appreciated that the present invention should not be construed as limited by such embodiments, but rather construed according to the following claims.

What is claimed is:

1. A method of providing rated content, said method comprising:
sending said content to a device operable for rendering said content, wherein rendered said content changes as a function of time; and
sending a plurality of rating values associated with said content to said device, wherein said plurality of rating values represent at least one person's opinion of said content, wherein said plurality of rating values are displayed and correspond to different moments in said content.

2. The method of claim 1 wherein said plurality of rating values are provided as a plot of rating value versus time.

3. The method of claim 1 wherein said plurality of rating values are provided as a graphical element-that has an attribute that changes as said rating values change.

4. The method of claim 1 wherein information identifying a person that contributed to said plurality of rating values is provided with said rating values.

5. The method of claim 1 wherein said plurality of rating values lie between a minimum value and a maximum value, wherein a rating value is provided as an icon that is selected depending on where said rating value lies relative to said minimum and maximum values.

6. A method of rating content, said method comprising:
rendering said content, wherein rendered said content has a time dimension;
displaying a first plurality of rating values associated with said content, wherein said first plurality of rating values represent at least one person's opinion of said content, wherein said first plurality of rating values correspond to different moments in said content; and
displaying a graphical user interface that is useful for receiving a second plurality of rating values, wherein said second plurality of rating values comprise a first rating value corresponding to a first amount of said content and a second rating value corresponding to a second amount of said content.

7. The method of claim 6 wherein a rating value of said first plurality of rating values is linked to a particular point in said content, wherein said content is rendered beginning at said point if said rating value is selected.

8. The method of claim 6 wherein said first plurality of rating values identify different attributes of said content.

9. The method of claim 6 further comprising displaying a third plurality of rating values associated with said content, wherein said third plurality of rating values represent at least one person's opinion of said content, wherein said third plurality of rating values correspond to different moments in said content.

10. The method of claim 9 wherein said first plurality of rating values are associated with a first attribute of said content and said third plurality of rating values are associated with a second attribute of said content.

11. The method of claim 9 wherein said first plurality of rating values are associated with a first group of users and said third plurality of rating values are associated with a second group of users.

12. The method of claim 9 wherein said first plurality of rating values are associated with a first user and said third plurality of rating values are associated with a second user.

13. The method of claim 6 further comprising prompting a user to enter a rating value at periodic intervals.

14. The method of claim 6 further comprising:
monitoring elapsed time since said rendering was started;
receiving a rating value during said rendering;
recording an amount of elapsed time when said rating value is received; and
associating said rating value with said amount of elapsed time.

15. The method of claim 6 further comprising:
receiving a rating value during said rendering;
identifying which point in said content was being rendered when said rating value was received; and
associating said rating value with a segment of said content that includes said point.

16. The method of claim 6 further comprising associating user information with said second plurality of rating values.

17. A system for distributing rated content, wherein said content has a time-dependent characteristic, said system comprising:
a ratings compiler that receives a first plurality of time-dependent rating values from one or more users, said first plurality of rating values representing said one or more users' opinions of said content and corresponding to different points in said content, wherein said ratings compiler is operable for aggregating said first plurality of rating values to produce time-dependent composite rating values that correspond to different points in said content; and
a content source coupled to said ratings compiler, wherein said content source sends said content and rating information comprising said first plurality of rating values to a device operable for rendering said content.

18. The system of claim 17 wherein said ratings compiler receives a second plurality of time-dependent rating values from said device and updates said composite rating values to include said second plurality of rating values.

19. The system of claim 18 wherein said ratings compiler uses said second plurality of rating values to identify other content.

20. The system of claim 18 wherein said ratings compiler associates user information with said second plurality of rating values.
